(19) United States
(12) Patent Application Publication
(10) Pub. No.: US 2024/0220202 A1
(43) Pub. Date: Jul. 4, 2024

(54) Multi-Modal Systolic Array For Matrix Multiplication

(71) Applicant: Google LLC, Mountain View, CA (US)

(72) Inventors: Matthew Leever Hedlund, Sun Prairie, WI (US); Christopher Aaron Clark, Madison, WI (US); Andrew Everett Phelps, Middleton, WI (US); Thomas James Norrie, San Jose, CA (US); Norman Paul Jouppi, Palo Alto, CA (US); Sushma Honnavara-Prasad, Los Gatos, CA (US); Vinayak Anand Gokhale, Austin, TX (US); Pareesa Ameneh Golnari, Bellevue, WA (US)

(21) Appl. No.: 18/168,972

(22) Filed: Feb. 14, 2023

Related U.S. Application Data
(60) Provisional application No. 63/477,836, filed on Dec. 30, 2022.

(51) Int. Cl. G06F 7/544; G06F 7/485; G06F 7/487; G06F 15/80

(52) U.S. Cl. CPC G06F 7/5443; G06F 7/485; G06F 7/4876; G06F 15/8046

(57) ABSTRACT

A system and method for matrix multiplication using a systolic array configurable between multiple modes of operation. A systolic processor may receive a data type indicator for the matrix multiplication. For a first data type, the systolic processor may load the right-hand side data from the right-hand matrix register into the data processing cells of the systolic array between row 0 and row M−1, and pass the respective row of the left-hand side data through a corresponding row of the systolic array between rows 0 and M−1. For a second data type, the systolic processor may split each element of the left-hand side data and the right-hand side data into respective first and second element halves, and move each element half through a corresponding row of the systolic array between rows 0 and 2M−1.

### CROSS-REFERENCE TO RELATED APPLICATION

The present application claims the benefit of the filing date of U.S. Provisional Patent Application No. 63/477,836 filed Dec. 30, 2022, the disclosure of which is hereby incorporated herein by reference.

### BACKGROUND

Accelerators for neural networks, such as deep neural networks (DNN), have leveraged systolic arrays for high-density computation. Systolic arrays are arrays of processing elements, such as processors, microprocessors, or specialized circuitry configured to process some data. Adjacent processing elements of a systolic array can be connected through one or more interconnects, e.g., wires or other physical connections, for example on a printed circuit board.

Existing systolic arrays leverage one or more matrix multiplication units (MXU) within a processor to perform matrix multiplication operations. In order for processors to achieve high performance in matrix multiplication, a data format called brain floating point of “bfloat16” or “bf16” for short, is used for multiply-accumulate operations within the MXUs. bf16 is a 16-bit floating point format including one sign bit, eight exponent bits, and seven mantissa bits. Adapting the systolic array architecture to support the bf16 data type has been found to save on-chip memory and increase processing speed. However, these adaptations also limit the types of data formats that can be processed using the systolic array.

### BRIEF SUMMARY

The present disclosure provides a new systolic array architecture that allows for data of multiple data types to be processed, meaning that matrix multiplication operations may be performed with high efficiency for both bf16 and other data types, such as 4-bit integer values, 8-bit integer values, and 8-bit floating point values.

In one aspect of the disclosure, a system for performing matrix multiplication of input data including left-hand side data and right-hand side data includes: a right-hand matrix register having size M×N; a systolic array of data processing cells configurable between a first size M×N and a second size 2M×N; and a systolic processor configured to: receive a data type indicator indicating a data type of the input data; (i) in response to the data type indicator indicating a first data type: load the right-hand side data from the right-hand matrix register into the data processing cells between rows 0 and M−1; and pass each respective row of the left-hand side data through a corresponding row of the systolic array between rows 0 and M−1; (ii) in response to the data type indicator indicating a second data type: split each element of the left-hand side data and the right-hand side data into respective first and second element halves; load each first element half from the right-hand matrix register into the data processing cells between rows 0 and M−1; and load each second element half from the right-hand matrix register into the data processing cells between rows M and 2M−1; and for each respective row of the left-hand side data: pass the first element half of the respective row of the left-hand side data through a corresponding row of the data processing cells between rows 0 and M−1; and pass the second element half of the respective row of the left-hand side data through a corresponding row of the data processing cells between rows M and 2M−1.

In some examples, the first data type may include at least one of 8-bit integer, 8-bit floating point, or 16-bit floating point, and the second data type may include 4-bit integer.

In some examples, the systolic processor may be configured to: in response to the data type indicator indicating 16-bit floating point or 8-bit floating point, pass a vector of elements of the left-hand side data having shape 1*M at each matrix multiplication cycle; in response to the data type indicator indicating 8-bit integer, pass a vector of elements of the left-hand side data having shape 2*M per matrix multiplication cycle; and in response to the data type indicator indicating 4-bit integer, pass a vector of elements of the left-hand side data having shape 2*2M per matrix multiplication cycle.

In some examples, the system may further include one or more 16-bit floating point multiply-add chains, two additional 8-bit integer multiply-add chains for every 16-bit floating point multiply-add chain, and two additional 4-bit multiply-add chains for every 16-bit floating point multiply-add chain. The systolic processor may be configured to process 8-bit floating point and 16-bit floating point data using the 16-bit floating point multiply-add chain, process 8-bit integer data using the two 8-bit integer multiply-add chains, and process 4-bit integer data using the two 8-bit integer multiply-add chains and the two 4-bit integer multiply-add chains.

In some examples, the systolic processor may be configured to produce 2×M 24-bit results per cycle for 8-bit and 4-bit integer inputs, and 1×M 32-bit results per cycle for 8-bit and 16-bit floating point inputs

In some examples, the system may further include a holding register having size M×N and configured to provide the right-hand side data to the right-hand matrix register. The holding register may be configured to contain at least one data type that is not supported by the systolic array. The systolic processor may be configured to convert right-hand side data of an unsupported data type to right-hand side data of a supported data type as the right-hand side data is provided from the holding register to the right-hand matrix register.

In some examples, the unsupported data type may be an 8-bit floating point data type, and the systolic processor may be configured to convert right-hand side data of the unsupported data type contained in the holding register to the 16-bit floating point data type as the right-hand side data is provided from the holding register to the right-hand matrix register.

In some examples, the data processing cell of the systolic array may include a floating point dot product accumulator configured to process the left-hand side and right-hand side data having a floating point data type, and a plurality of integer dot product accumulators configured to process the left-hand side and right-hand side data having an integer data type.

In some examples, the systolic processor may be configured to, in response to the data type indicator indicating the floating point data type, pass data from one vector from the left-hand side data to the floating point dot product accumulator per matrix multiplication cycle, and in response to the data type indicator indicating the integer data type, pass data from two vectors from the left-hand side data to the plurality of integer dot product accumulators per matrix multiplication cycle. Each integer dot product accumulator may receive data from a respective vector of the left-hand side data.

In some examples, each integer dot product accumulator may further include separate first and second datapaths, and each datapath may include a respective partial product generation layer, a respective carry-save adder tree layer, and a respective reduction tree layer.

In some examples, the systolic processor may be configured to, in response to the data type indicator indicating an 8-bit integer data type, pass data from the left-hand side data to only the first datapath of each integer dot product accumulator at each matrix multiplication cycle, and in response to the data type indicator indicating a 4-bit integer data type, pass data from the left-hand side data to both the first datapath and the second datapath of each integer dot product accumulator at each matrix multiplication cycle.

In some examples, for each element of the left-hand data, the systolic processor may be configured to pass the first element half to the first datapath of a corresponding one of the integer dot product accumulators, and pass the second element to the second datapath of the second corresponding one of the integer dot product accumulators.

Another aspect of the disclosure is directed to an accelerator hardware unit including a system as described in any of the embodiments herein. The accelerator hardware unit may be one of a graphics processing unit or a tensor processing unit. In some examples, the accelerator hardware unit may include a plurality of matrix multiplication units, and at least one of the matrix multiplication units may include the system as described in any of the embodiments herein.

Yet a further aspect of the disclosure is directed to a method for performing matrix multiplication in a systolic array of data processing cells configurable between a first size of M×N and a second size of 2M×N, the method including: receiving, by one or more processors, a data type indicator indicating a data type of input data for the matrix multiplication, the input data including left-hand side data and right-hand side data; (i) in response to the data type of the data type indicator indicating the first data type: loading, by the one or more processors, the right-hand side data from a right-hand matrix register having size M×N into the data processing cells of the systolic array between row 0 and row M−1; and for each respective row of the left-hand side data, passing, by the one or more processors, the respective row of the left-hand side data through a corresponding row of the data processing cells of the systolic array between row 0 and row M−1 to derive a matrix multiplication result of the left-hand side data with the right-hand side data; (ii) in response to the data type of the data type indicator indicating the second data type: splitting, by the one or more processors, each element of the left-hand side data and the right-hand side data into respective first and second element halves; loading, by the one or more processors, each first element half from the right-hand matrix register into the data processing cells of the systolic array between row 0 and row M−1; and loading, by the one or more processors, each second element half from the right-hand matrix register into the data processing cells of the systolic array between row M and row 2M−1; for each respective row of the left-hand side data: passing, by the one or more processors, the first element half of the respective row of the left-hand side data through a corresponding row of the data processing cells of the systolic array between row 0 and row M−1; and passing, by the one or more processors, the second element half of the respective row of the left-hand side data through a corresponding row of the data processing cells of the systolic array between row M and row 2M−1, to derive the matrix multiplication result of the left-hand side data with the right-hand side data.

In some examples, the first data type may include at least one of 16-bit floating point, 8-bit floating point or 8-bit integer, and the second data type may include 4-bit integer. In some examples, in response to the data type indicator indicating the first data type, passing the left-hand side data may involve passing one or more vectors of elements of the left-hand side data to only rows 0 through M−1 of the systolic array at each matrix multiplication cycle, and in response to the data type indicator indicating the second data type, passing the left-hand side data may involve passing one or more vectors of elements of the left-hand side data to all rows between 0 through 2M−1 of the systolic array at each matrix multiplication cycle.

In some examples, in response to the data type indicator indicating the second data type, passing the left-hand side data may involve passing two vectors of elements of the left-hand side data to a plurality of integer dot product accumulators included in each cell of the systolic array per matrix multiplication cycle. Each cell may include two integer dot product accumulators, and each pair of corresponding rows may correspond to a pair of separate datapaths within a corresponding one of the plurality of integer dot product accumulators.

In some examples, the data type indicator may further differentiate between integer and floating point data types. For example, in response to the data type indicator indicating the floating point data type, passing the left-hand side data may involve passing one vector of elements of the left-hand side data to the systolic array at each matrix multiplication cycle, and in response to the data type indicator indicating the integer data type, passing the left-hand side data may involve passing two vectors of elements of the left-hand side data to the systolic array at each matrix multiplication cycle.

In some examples, the method may further include storing the right-hand side data in a holding register having size M×N, the right-hand side data being a data type that is not supported by the systolic array, loading the right-hand side data from the holding register into the right-hand matrix register, whereby loading involves converting, by the one or more processors, the right-hand side data into a data type that is supported by the systolic array, and the data type that is not supported by the systolic array is 8-bit floating point whereas the data type that is supported by the systolic array is 16-bit floating point.

In some examples, the left-hand side and right-hand side data may be received as 128×128 matrices, whereby M=128 and N=128, and the method may further include, for data inputs including 8-bit or 16-bit floating point operands, producing 1×128 32-bit floating point results for each cycle of the systolic array, and for data inputs including 4-bit or 8-bit integer operands, producing 2×128 24-bit results for each cycle of the systolic array.

### BRIEF DESCRIPTION OF THE DRAWINGS

FIG. 1 is a block diagram of a systolic array in accordance with an aspect of the present disclosure.

FIGS. 2A and 2B are block diagrams of an example cell included in the systolic array of FIG. 1.

FIG. 3 is a block diagram of an example accumulator included in the cell of FIGS. 2A and 2B.

FIGS. 4-7 are diagrams illustrating example data flows within the systolic array of FIGS. 1-3.

FIGS. 8A-8C are diagrams illustrating shapes of example matrix multiplication and addition operations performed by a systolic array in accordance with an aspect of the present disclosure.

FIG. 9 is a block diagram of an example electronic device in accordance with an aspect of the disclosure.

FIG. 10 is a flow diagram of an example routine for loading and passing data in a systolic array in accordance with an aspect of the disclosure.

### DETAILED DESCRIPTION

### Overview

A systolic array is arranged to perform matrix multiplication operations on operands of two or more different data type formats, such as 4-bit integer operands, 8-bit integer operands, 8-bit floating point operands, or 16-bit floating point operands. The systolic array uses at least some of the same input busses and same output busses for multiple formats. Additionally, the cells of the systolic array include processing elements to support each of 16-bit floating point by 16-bit floating point multiplications, 8-bit integer by 8-bit integer multiplications, and 4-bit integer by 4-bit integer multiplications. For instance, each cell of the systolic array may include a single 16-bit floating point dot product accumulator (DPA) to support 16-bit floating point by 16-bit floating point matrix multiplication operations, and a pair of 8-bit integer DPAs to support both 8-bit integer by 8-bit integer and 4-bit integer by 4-bit integer matrix multiplication operations.

A systolic processor, which may include several processing elements for operating the systolic array, may receive an indication of the data type of both the right-hand side data loaded into the array and the left-hand side data flowing into the array, and determine how to input and process the data into the systolic array based on the received indication of data type. The indication may be received in the form of a flag, and may indicate whether the data type is integer or floating point, a size of the data type, such as 4-bit, 8-bit or 16-bit, and in some circumstances other characteristics of the data type that may be necessary for performing the proper matrix multiplication operations.

In the case of 16-bit floating point operands stored in the form of an M×N elements matrix, the right-hand side data is loaded into a systolic array between rows 0 and M−1 of the array, and each element of the left-hand side data may be passed through a respective row of the systolic array between rows 0 and M−1 of the array. In such a case, the 16-bit floating bit inputs may effectively be interpreted as 1×M elements per matrix multiplication cycle of the systolic array, and the output of the array may be 1×M 32-bit floating point (also referred to as “f32”) results per cycle.

In the case of 8-bit floating point operands stored in the form of an M×N elements matrix, the 8-bit operands may be converted to 16-bit floating point operands such that they flow into and out of the systolic array in the same manner as the 16-bit floating point operands.

In the case of 8-bit integer operands stored in the form of an M×N elements matrix, like with 16-bit floating point elements, each element of the right-hand side data may be loaded into the systolic array between rows 0 and M−1 of the array, and each element of the left-hand side data may be passed through a respective row of the systolic array between rows 0 and M−1 of the array. However, unlike the 16-bit floating point elements, since each cell of the systolic array is capable of twice the throughput for 8-bit integer operations, each cell of the systolic array may receive and process two rows of 8-bit integer elements in parallel per cycle. In such a case, the 8-bit integer inputs may effectively be interpreted as 2×M elements per matrix multiplication cycle of the systolic array, and the output of the array may be 2×M 24-bit results per cycle.

Lastly, in the case of 4-bit integer operands stored in the form of an M×N elements matrix, each element of the stored matrix may contain two separate 4-bit operand instead of containing a single 8-bit operand. As a result, when the elements are moved into the systolic array, each element may be interpreted as two element halves, whereby each element half is a separate 4-bit integer operand. Since the stored M×N matrix of elements is interpreted as having twice as many elements per row, each element half of the right-hand side data may be loaded into a respective row of the systolic array between rows 0 and 2M−1 of the array, and each element half of the left-hand side data may be passed through a respective row of the systolic array between rows 0 and 2M−1 of the array. In such a case, the 4-bit integer inputs may effectively be interpreted as 2×2M elements per matrix multiplication cycle of the systolic array. Furthermore, the 4-bit integer inputs may effectively be interpreted as 2×2M elements per matrix multiplication cycle, and the output of the array may be 2×M 24-bit results per cycle.

The disclosed systolic array architecture provides the advantage of being able to process multiple data types, including both integer and floating point values of different sizes, while maintaining good throughput. Instead of providing completely different hardware for each data type, the same input and output busses can be used for the varying data types to feed into varying accumulators included in the systolic array. Ultimately, these advantages are beneficial to maintaining a highly efficient processor capable of handling many different data types without sacrificing undue space for added hardware to support the different data types.

### Example Systems

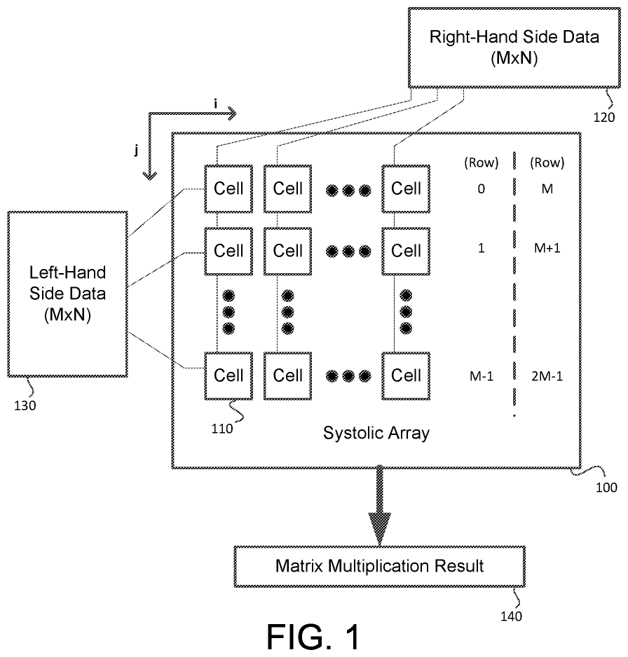

FIG. 1 is a diagram of an example systolic array 100 in accordance with an aspect of the present disclosure. The systolic array 100 is shown as having a plurality of cells 110 arranged in an [I,J] array having I rows and J columns.

Each of the cells 110 may be loaded with right-hand side data from a right-hand matrix register 120. The right-hand matrix register 120 may be shaped as an M×N matrix having M rows and N columns of data elements. Typically, each data element corresponds to a separate operand for matrix multiplication operations, although in at least some circumstances of the present disclosure each data element may contain multiple operands.

A first column [0] of the cells 110 may also receive left-hand side data from a left-hand vector register 130. The left-hand matrix register 130 may also be shaped as an M×N matrix having M rows and N columns of data elements. As with the right-hand side data, each data element typically corresponds to a separate operand for matrix multiplication operations, although in at least some circumstances of the present disclosure, each data element may contain multiple operands.

In some examples, the systolic array may be stationary, meaning that the entire right-hand matrix register 120 is loaded in advance and remains stationary in the array during matrix multiplication. Alternatively, in other examples, a vector of right-hand side data may be loaded per cycle, making the systolic array non-stationary. The decision between a stationary or non-stationary array may be influenced by timing considerations within the systolic array, such as control flow direction and pipelining.

Each cell 110 of the systolic array 100 may be responsible for receiving a portion of right-hand side data, receiving a portion of left-hand side data, receiving an output from a previous cell in the same row, calculating a product of the received portions of right-hand side and left-hand side data, adding the calculated product to the output from a previous cell, and passing the sum to the next cell in the same row. For instance, in the case of a given cell [i,j] of the systolic array, the right-hand side data loaded into the cell received may correspond to a column [n] of the right-hand matrix register 120, the left-hand side data that is passed through the cell may correspond to a row [m] of the left-hand vector register 130, an output may be received from cell [i−1,j], a product of the received portions of [m] and [n] may be calculated and added to the output from cell [i−1, j], and the sum may be forwarded to the next cell [i+1,j]. Ultimately, the calculations performed by each of the cells 110 may amount to the matrix multiplication result 140.

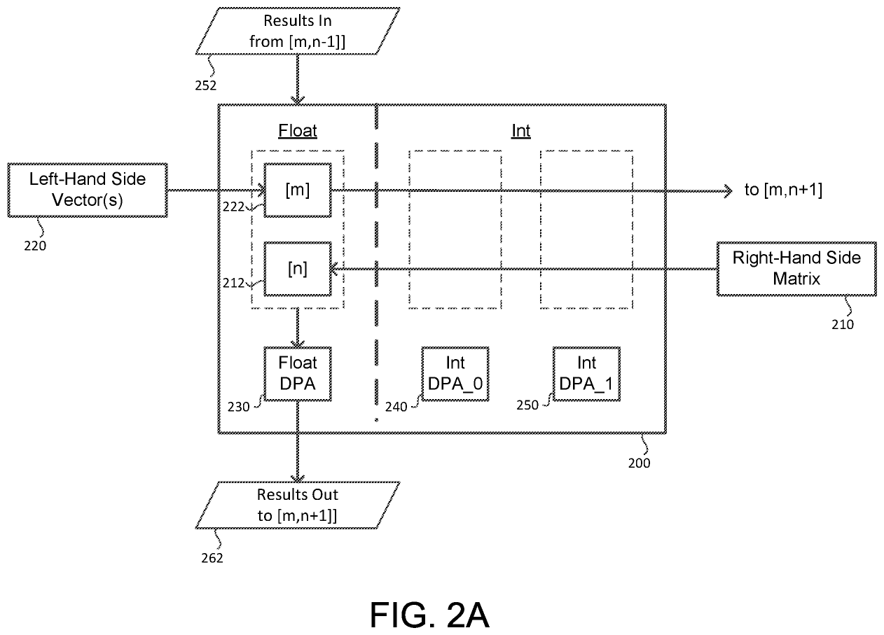

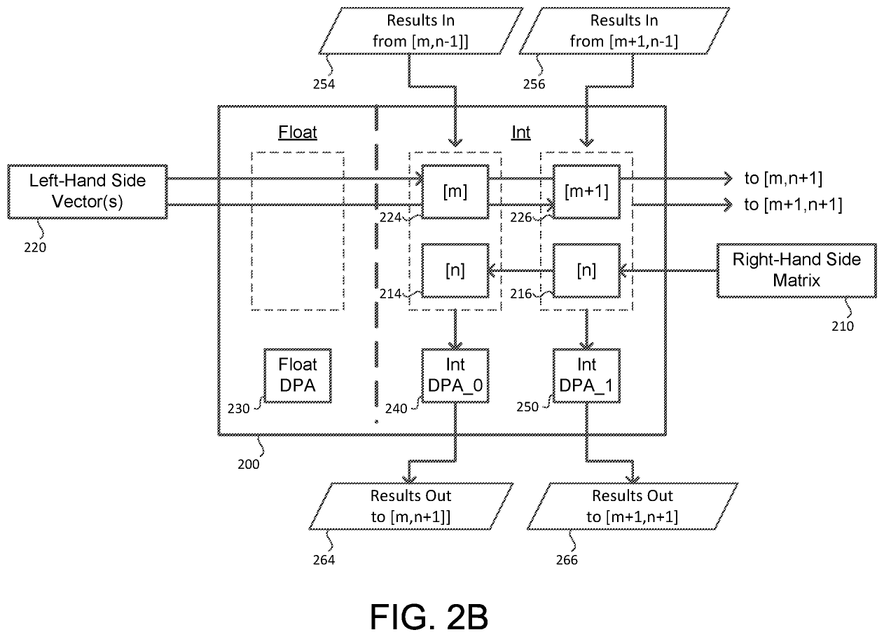

FIGS. 2A and 2B are block diagrams of an example individual cell 200, such as a cell 110 of the systolic array 100 of FIG. 1. The cell 200 includes processing elements capable of receiving right-hand side data 210 and left-hand side data 220, as well as receiving computed values from a previous cell along the row of the systolic array. In the example of FIGS. 2A and 2B, the cell 200 is shown to include one dot product accumulator (DPA) for floating point values (Float DPA 230), and two dot product accumulators (DPAs) for integer values (Int DPA_0 240 and Int DPA_1 250). The Float DPA 230 is used for processing incoming floating point operands, and the Int DPAs 240, 250 are used for processing incoming integer operands.

The example of FIG. 2A shows data flow for incoming floating point operands. In the example of FIG. 2A, the floating point operands may be 16-bit operands or 8-bit operands. In other examples, the floating point operands may be a different size. The cell 200 receives right-hand side data 212 from column [n] of the right-hand side matrix 210. Additionally, in each cycle of the systolic array, the cell 200 receives left-hand side data 222 corresponding to row [m] of a vector of the left-hand side matrix 220 from a previous cell of the systolic array. The cell further receives the results 252 of a previous cell [m,n−1], which are the results of computations performed on row [m] of the left-hand side data and column [n−1] of the right-hand side data added to any previous results along row [m]. Computations are performed in the floating point DPA 230, in which a dot product of the left-hand side data 222 and right-hand side data 212 is calculated and then added to the results 252 of the previous cell. At a next cycle, the left-hand side data 222 is then passed to a next cell [m,n+1] along the row, along with the calculated results 262 of the computation.

The example of FIG. 2B shows data flow for incoming integer operands. In the example of FIG. 2B, the integer operands may be 8-bit operands or 4-bit operands. In other examples, the integer operands may be a different size. The cell 200 receives right-hand side data 214, 216 from column [n] of the right-hand side matrix 210. Additionally, in each cycle of the systolic array, the cell 200 receives two rows of left-hand side data 224, 226 corresponding to rows [m] and [m+1] of two vectors of the left-hand side matrix 220 from a previous cell of the systolic array. The cell further receives the results 254, 256 of a previous cell [m,n−1]. Results 254 are the results of computations performed on row [m] of the left-hand side data and column [n−1] of the right-hand side data added to any previous results along row [m]. Results 256 are the results of computations performed on row [m+1] of the left-hand side data and column [n−1] of the right-hand side data added to any previous results along row [m+1]. Computations for each row [m] and [m+1] are performed in respective integer DPAs 240, 250, in which a dot product of the respective left-hand side data 224, 226 and respective right-hand side data 214, 216 is calculated and then added to the results 254, 256 of the respective previous cell [m,n−1] or [m+1,n−1]. At a next cycle, each portion of left-hand side data 224, 226 is then passed to its respective next cell [m,n+1] or [m+1,n+1] along its respective row, along with the respective calculated results 264, 266 of the computation for that row.

It can be seen from FIG. 2B that 8-bit integer operations of the cell 200 have double the throughput as compared to 16-bit floating point operations. This double throughput is achieved efficiently, since the cost of passing 16 bits of data for a 16-bit floating point operand is comparable to the cost of passing 16 bits of data for two 8-bit integer operands. Additionally, although double the dot product accumulation operations may need to be performed for two operands as compared to one, the cell 200 is equipped with double the accumulators for the 8-bit integer operands, so there is no loss in efficiency at the computation stage either.

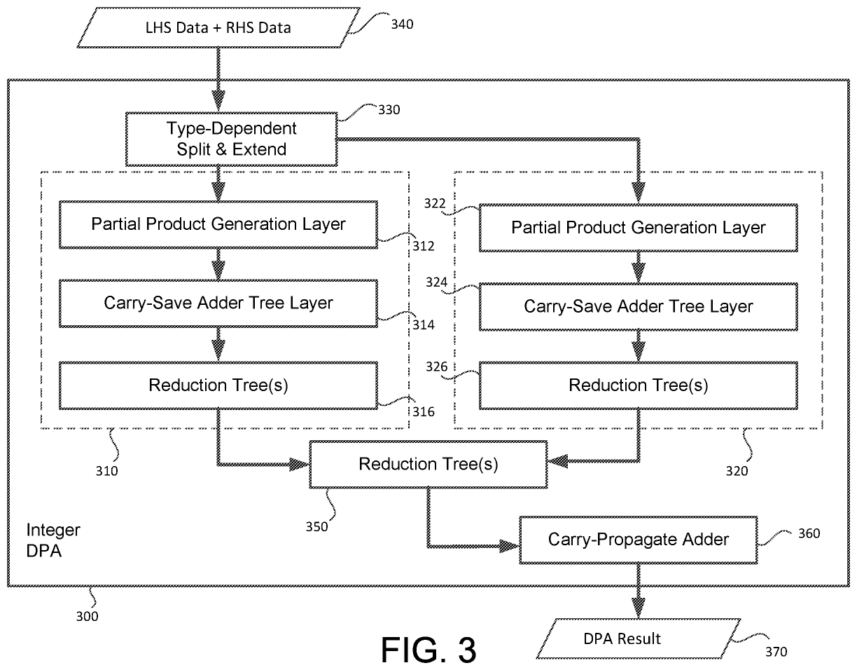

The cell of FIGS. 2A and 2B is also capable of handling 4-bit integers with high efficiency. This is accomplished by including two separate datapaths for inputs within the integer DPA. FIG. 3 is a block diagram of an example integer DPA 300 including a first datapath 310 utilized for processing of both 4-bit integer operands and 8-bit integer operands, and a second datapath 320 utilized only for processing 4-bit integer operands. Each datapath 310, 320 includes a respective partial product generation layer 312, 322, a respective carry-save adder tree layer 314, 324, and a respective reduction tree layer including one or more reduction trees 316, 326. The components used for these layers 312, 314, 316, 322, 324, 326 may be any conventional components known in the art for executing dot product accumulation for integer operands, such as 8-bit integers or 4-bit integers.

The DPA 300 may further include circuitry, shown in FIG. 3 as a “type-dependent split and extend” operation 330, for controlling whether the input data 340 received from the right-hand matrix register and from the previous cell is maintained as one input or split into two inputs. In one example, the data may be maintained as one input when the data type is a first data type, such as an 8-bit integer, and may be split into two inputs when the data type is a second data type, such as a 4-bit integer.

The DPA 300 may further include another reduction tree(s) 350 for combining the outputs of each of the two datapaths. Operations at the further reduction tree(s) 350 may be skipped for scenarios in which the input data 340 is not split. The DPA may also further include a carry-propagate adder 360 for adding the results from the previous cell to those of the current cell. The DPA result 370 may be output from the carry-propagate adder 360 and provided to the next cell along the corresponding row. In some examples, the further reduction tree(s) 350 and carry-propagate adder 360 may be shared with the floating point DPA of the cell instead of providing separate reduction trees and carry-propagate adders for both floating point and integer pathways within the DPA. Alternatively, separate reduction trees and carry-propagate adders may be provided.

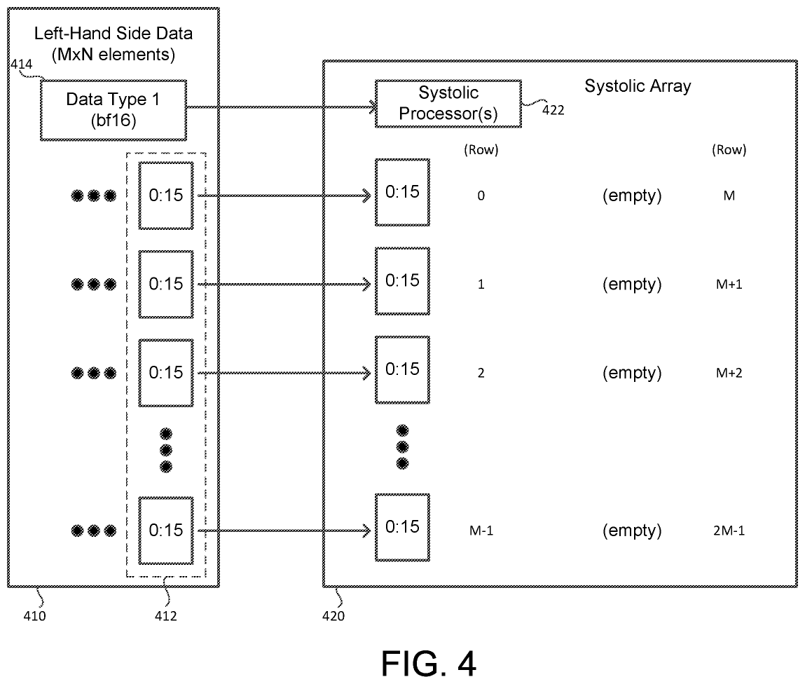

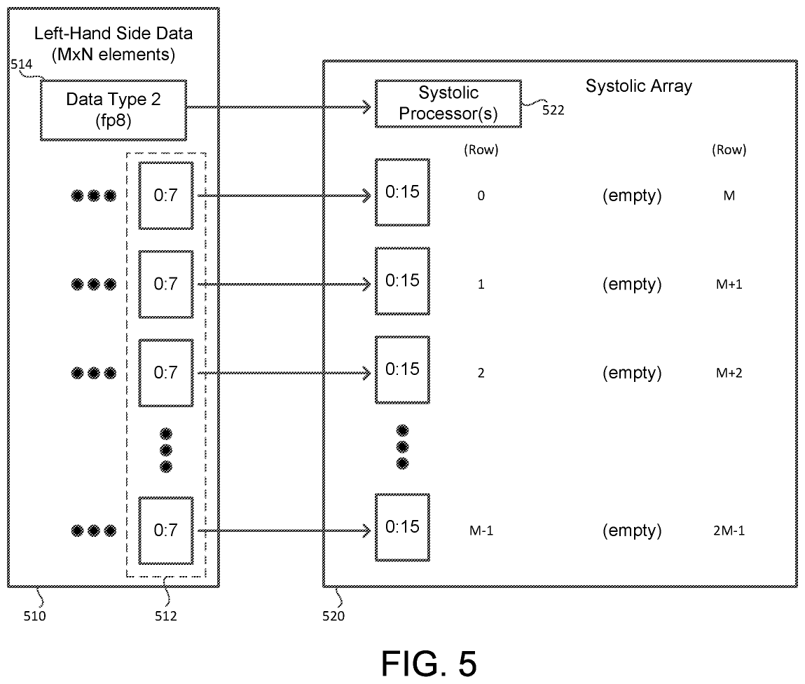

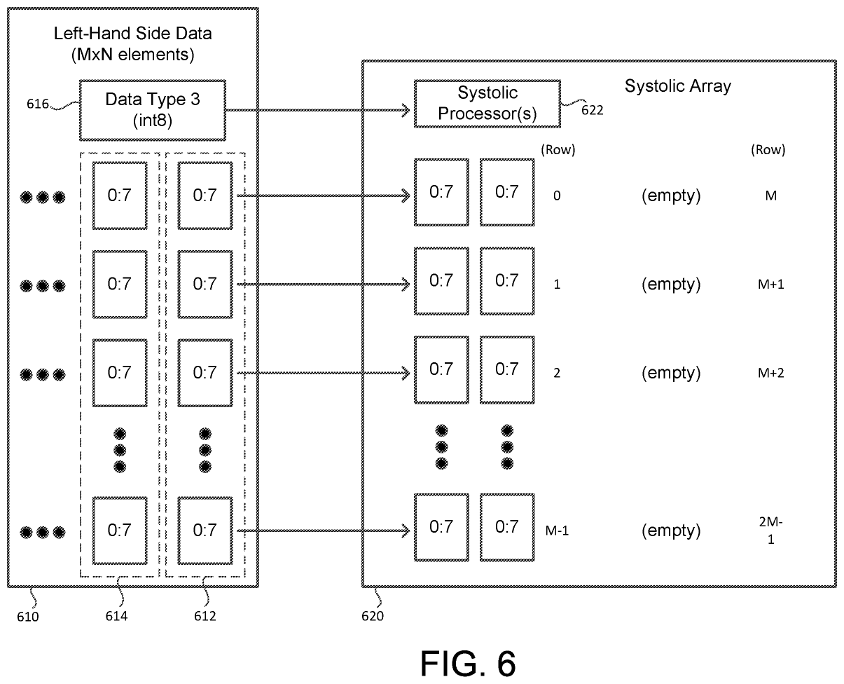

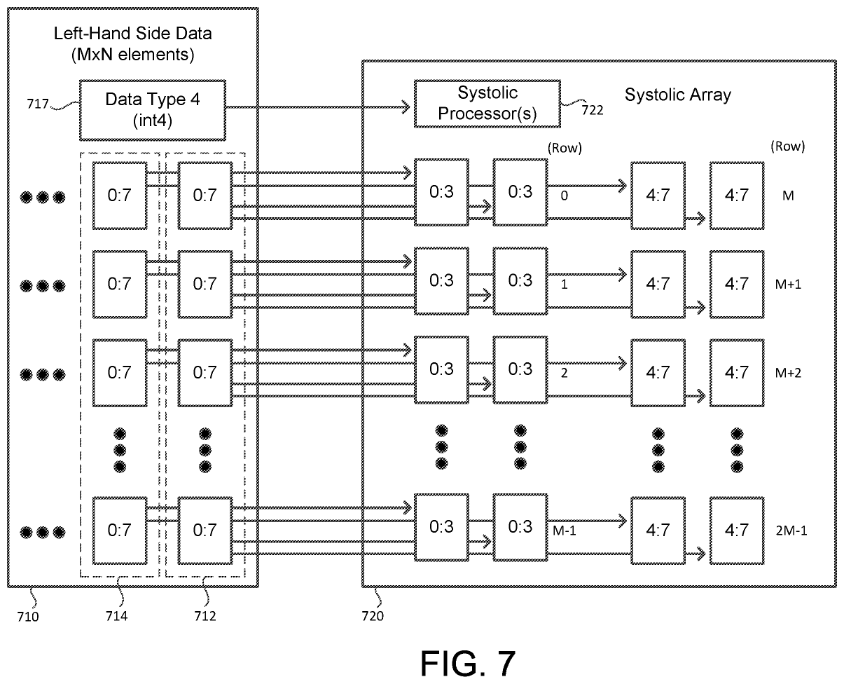

FIGS. 4-7 are block diagrams illustrating example data flows for different data types that may be received by a systolic array of the present disclosure. The example of FIG. 4 illustrates data flow for 16-bit floating point operands, the example of FIG. 5 illustrates data flow for 8-bit floating point operands, the example of FIG. 6 illustrates data flow for 8-bit integer operands, and the example of FIG. 7 illustrates data flow for 4-bit integer operands.

In the example of FIG. 4, left-hand side data 410 from a matrix having shape M×N is provided to the systolic array 420. The left-hand side data 410 includes a vector 412 of M 16-bit elements having a shape of 1×M, and a data type indicator 414 indicating a data type of the vector of elements. In the example of FIG. 4, the elements are indicated to be “bf16,” which is a type of 16-bit floating point value. In response, the systolic processors 422 of the systolic array 420 control the flow of the M elements into rows 0 through M−1 of the systolic array, whereby each element occupies a respective row. Another vector 412 may be passed from the left-hand side data 410 to the systolic array 420 at each cycle of the matrix multiplication operations.

In the example of FIG. 5, left-hand side data 510 from a matrix having shape M×N is provided to the systolic array 520. The left-hand side data 510 includes a vector 512 of M 8-bit elements having a shape of 1×M, and a data type indicator 514, indicating that the data type of the vector of elements is “fp8,” which is a type of 8-bit floating point value. In response, the systolic processors 522 of the systolic array 520 may control the conversion of the 8-bit elements into “bf16” 16-bit floating point values and then control the flow of the M converted elements into rows 0 through M−1 of the systolic array 520, whereby each element occupies a respective row. Another vector 512 may be converted and passed from the left-hand side data 510 to the systolic array 520 at each cycle of the matrix multiplication operations.

In the example of FIG. 6, left-hand side data 610 from a matrix having shape M×N is provided to the systolic array 620. The left-hand side data 610 includes two vectors 612, 614, each having M 8-bit elements having a shape of 1×M, and a data type indicator 616 indicating that the data type of the vector of elements is “int8,” which is a type of 8-bit integer value. In response, the systolic processors 622 of the systolic array 620 may control the flow of an element from each of the vectors into a respective row between rows 0 through M−1 of the systolic array 620, whereby each element occupies a respective row, and each row receives two elements. Another two vectors 612, 614 may be converted and passed from the left-hand side data 610 to the systolic array 620 at each cycle of the matrix multiplication operations.

As can be seen from the example of FIG. 6, the ability for the systolic array to receive and process two vectors of int8 data within a single cycle allows for the matrix multiplication operations for the entire matrix of int8 data to be completed twice as fast as compared to in a systolic array that receives only one vector at a time. Thus, the efficiency of the systolic array can be maintained, as the speed for processing the elements within the array can correspond to the speed at which the elements can be streamed into the array.

Lastly, in the example of FIG. 7, left-hand side data 710 from a matrix having shape M×N is provided to the systolic array 720. The left-hand side data 710 includes two vectors 712, 714, each having M 8-bit elements, and each element containing two operands, thus giving each vector of operands a shape of 1×2M. The left-hand side data 710 also includes a data type indicator 716, indicating that the data type of the vector of elements is “int4,” which is a type of 4-bit integer value. In response, the systolic processors 722 of the systolic array 720 may control the splitting of each element from an 8-bit element into 2 4-bit elements, whereby a first half of the 8-bit element from bits 0 to 3 makes up the first element half that corresponds to a first 4-bit operand, and a second half of the 8-bit element from bits 4 to 7 makes up the second element half that corresponds to a second 4-bit operand. The systolic processors 722 then control the flow of the element halves to respective rows of the systolic array. For a first element half that is directed to row [m] of the array, the corresponding second element half may be directed to a corresponding row [M+m], which may be physically co-located with row [m] in the same DPA of the systolic array cell. In this manner, for each 1×M vector 712, 714 of elements of the left-hand side data 710, the operands are provided to 2M rows of the systolic array. As with the 8-bit integer operands in the example of FIG. 6, the 4-bit integer operands may flow into the systolic array two vectors per cycle of the matrix multiplication operations.

As can be seen from the example of FIG. 7, the ability of the systolic array to receive and process two vectors of int4 data within a single cycle, and further to process two rows of int4 data within a single cell of the systolic array, allows for the matrix multiplication operations for the entire matrix of int4 data to be completed four times as fast as compared to in a systolic array that receives only one vector at a time and processes only one element per cell. Thus, the efficiency of the systolic array can be maintained, as the speed for processing the elements within the array can correspond to the speed at which the elements can be streamed into the array

Although not shown in FIGS. 4-7, the process of loading the right-hand side data into the systolic array may be comparable to the process of streaming in left-hand side data. For example, in the case of 16-bit floating point values, 8-bit floating point values, and 8-bit integer values, the right-hand side data may be loaded into rows 0 through M−1 of the systolic array. Further, in the case of 8-bit floating point values, the right-hand side data may also be converted to the “bf16” 16-bit floating point value format. For further example, in the case of 4-bit integer values, each element of the right-hand side data may be split into two element halves and loaded into rows 0 through 2M−1 of the systolic array, whereby pairs of element halves are loaded into the physically co-located rows, such as rows 0 and M, or rows 1 and M+1, or rows 2 and M+2 and so on.

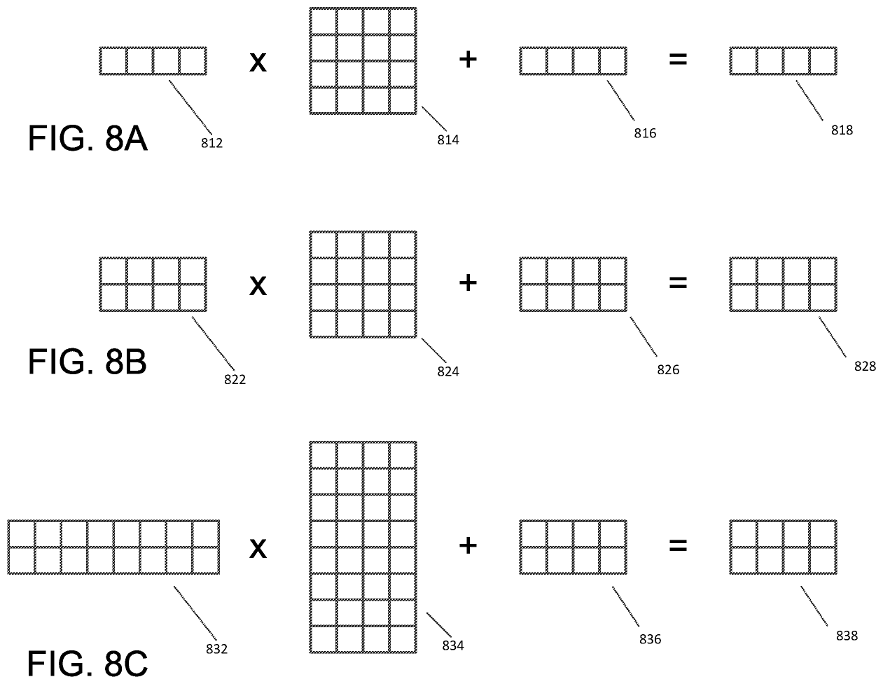

FIGS. 8A-8C are diagrams providing further visualization of the matrix multiplication operations performed in a given cycle of each of the example systolic arrays of FIGS. 4-7. The operations shown in FIG. 8A correspond to 16-bit floating point operations, which are performed by the example systolic arrays of FIGS. 4 and 5. The operations shown in FIG. 8B correspond to 8-bit integer operations, which are performed by the example systolic array of FIG. 6. The operations shown in FIG. 8C correspond to 4-bit integer operations, which are performed by the example systolic array of FIG. 7.

In the example of FIG. 8A, a 1×M vector of bf16 elements from the left-hand side data 812 is multiplied with an M×N matrix of bf16 elements from the right-hand side data 814. The bf16 elements may begin as 16-bit floating point values, or as 8-bit floating point values that are converted to 16-bit floating point values, such as by using a data type conversion instructions such as roundTiesToEven. Converting the 8-bit values to 16-bit values may further utilize a holding register having size M×N to store the right-hand side data for loading into the right-hand matrix register. In such examples, 8-bit floating point may be an unsupported data type for the right-hand matrix register, but may be a supported data type for the holding register. Thus, moving the 8-bit floating point values from vector registers into the holding register may facilitate the conversion of the 8-bit values to 16-bit values as the data is moved from the holding register to the right-hand matrix register.

In either the case of the data type indicator indicating 8-bit or 16-bit floating point values, the result of the matrix multiplication operations is a 1×M vector of 32-bit floating point operands that may be added to the 1×M vector derived from calculations in previous cells of the systolic array 816 for the array to arrive at a final output result 818 for the cycle, which itself is a 1×M vector of 32-bit floating point operands. The output may be in 32-bit floating point format so as to facilitate the accumulate operations.

In the example of FIG. 8B, two 1×M vectors of int8 elements from the left-hand side data 822 are multiplied with an M×N matrix of int8 elements from the right-hand side data 824. The multiplication operations for the two vectors may occur in parallel at each corresponding cell using the two integer DPAs of the corresponding cell. The result of the parallel matrix multiplication operations is a 2×M vector of 24-bit integer operands that may be added to the 2×M vector derived from calculations in previous cells of the systolic array 826 for the array to arrive at a final output result 828 for the cycle, which itself is a 2×M vector of 24-bit integer operands.

In the example of FIG. 8C, two 1×M vectors of 8-bit integer elements from the left-hand side data are split into two vectors of 1×2M 4-bit integer operands 832, and an M×N matrix of 8-bit integer elements from the right-hand side data are split into a 2M×N matrix of 4-bit integer operands 834 and loaded into the systolic array. The multiplication operations for the two vectors may occur in parallel at each corresponding cell using the two integer DPAs of the corresponding cell. Furthermore, at each integer DPA, physically co-located rows may receive respective portions of the left-hand side data. The result of the parallel matrix multiplication operations is a 2×2M vector of 24-bit integer operands that may be added to the 2×2M vector derived from calculations in previous cells of the systolic array 836 for the array to arrive at a final output result 838 for the cycle, which itself is a 2×2M vector of 24-bit integer operands.

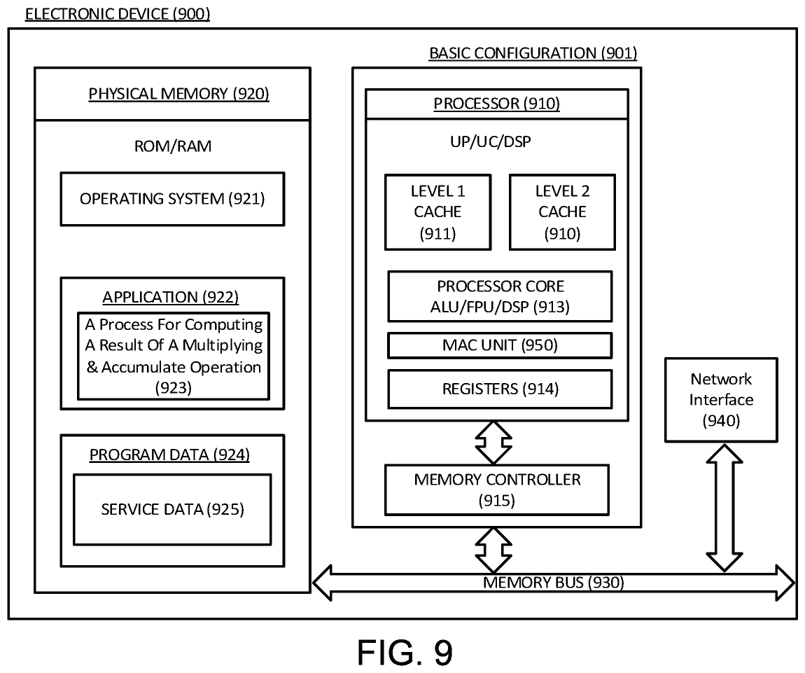

FIG. 9 depicts a block diagram of an example electronic device 900 for implementing a systolic array in accordance with any of the example embodiments of the present disclosure. The electronic device 900 may include one or more processor 910, such as one or more CPUs, system memory 920, a bus 930, the networking interface(s) 940, and other components (not shown), such as storage(s), output device interface(s), input device interface(s). A bus 930 may be used for communicating between the processor 910, the system memory 920, the networking interface(s) 940, and other components. Any or all components of electronic device 900 may be used in conjunction with the subject of the present disclosure.

Depending on the desired configuration, the processor 910 may be of any type including but not limited to one or more central processing units (CPUs), graphic processing units (GPUs), field-programmable gate arrays (FPGAs), and/or application-specific integrated circuits (ASICs), such as tensor processing units (TPUs), or any combination thereof. The processor 910 may include the systolic array. The processor 910 may include one more level of caching, such as a level one cache 911 and a level two cache 912, a processor core 913, and registers 914. The processor core 913 may include one or more arithmetic logic unit (ALU), one or more floating point unit (FPU), one or more DSP core, or any combination thereof. A memory controller 915 may also be used with the processor 910, or in some implementations the memory controller 915 can be an internal part of the processor 910.

Depending on the desired configuration, the physical memory 920 may be of any type including but not limited to volatile memory, such as RAM, non-volatile memory, such as ROM, flash memory, etc., or any combination thereof. The physical memory 920 may include an operating system 921, one or more applications 922, and program data 924, which may include service data 925. Non-transitory computer-readable medium program data 924 may include storing instructions that, when executed by the one or more processing devices, implement a process for computing the result of a multiply and accumulate operation 923. In some examples, the one or more applications 922 may be arranged to operate with program data 924 and service data 925 on an operating system 921.

The electronic device 900 may have additional features or functionality, and additional interfaces to facilitate communications between the basic configuration 901 and any required devices and interfaces.

Physical memory 920 may be an example of computer storage media. Computer storage media includes, but is not limited to, RAM, ROM, EEPROM, flash memory or other memory technology, or any other medium which can be used to store the desired information and which can be accessed by electronic device 900. Any such computer storage media can be part of the device 900.

Network interface(s) 940 may couple the electronic device 900 to a network (not shown) and/or to another electronic device (not shown). In this manner, the electronic device 900 can be a part of a network of electronic devices, such as a local area network (“LAN”), a wide area network (“WAN”), an intranet, or a network of networks, such as the Internet. In some examples, the electronic device 900 may include a network connection interface for forming a network connection to a network and a local communications connection interface for forming a tethering connection with another device. The connections may be wired or wireless. The electronic device 900 may bridge the network connection and the tethering connection to connect the other device to the network via the network interface(s) 940.

The systolic array may include a plurality of MAC units 950 to perform multiply and accumulate operations needed for matrix multiplication. The MAC units 950 and the systolic array in which it operates may be used in an accelerator that may be used for DNN implementations.

The electronic device 900 may be implemented as a portion of a small form factor portable (or mobile) electronic device such as a speaker, a headphone, an earbud, a cell phone, a smartphone, a smartwatch, a personal data assistant (PDA), a personal media player device, a tablet computer (tablet), a wireless web-watch device, a personal headset device, a wearable device, an application-specific device, or a hybrid device that include any of the above functions. The electronic device 900 may also be implemented as a personal computer including both laptop computer and non-laptop computer configurations. The electronic device 900 may also be implemented as a server, an accelerator, or a large-scale system.

### Example Methods

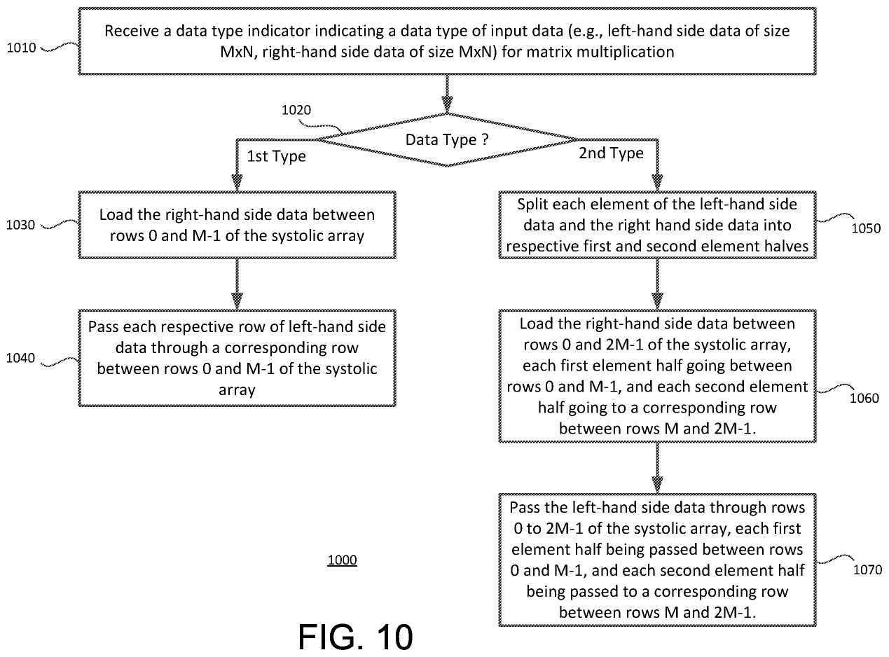

FIG. 10 is a flow diagram illustrating an example routine 1000 for controlling the flow of data through a systolic array of the present disclosure. The routine 1000 may be executed by the one or more systolic processors included in the system, such as the systolic processors shown in FIGS. 4-7.

Operations may begin at block 1010, at which the systolic processors receive a data type indicator indicating a data type of input data. The input data may include left-hand side data and right-hand side data for matrix multiplication within the systolic array. In some examples, the data type indicator may be a flag. In some examples, the flag may include one or more bits appended to the bits of the element.

At block 1020, the systolic processors may determine the data type of input data based on the data type indicator. For instance, the data type may be any one of 16-bit floating point, 8-bit floating point, 8-bit integer, 4-bit integer, and so on. In the example of FIG. 10, classification between two data types is shown, in which a first data type is handled according to a first set of operations and a second data type is handled according to a second set of operations.

If the data type corresponds to a first data type, corresponding to any of 16-bit floating point, 8-bit floating point, or 8-bit integer formats, then operations may continue at block 1030, in which the right-hand side data is loaded between rows 0 and M−1 of the systolic array, and then block 1040, at which each respective row of left-hand side data is passed through a corresponding row between rows 0 and M−1 of the systolic array. The left-hand side data may be passed one vector per cycle.

Alternatively, if the data type corresponds to a second data type, corresponding to the 4-bit integer format, then operations may continue at block 1050, at which each element of the left-hand side data and the right hand side data is split into respective first and second element halves, and then blocks 1060 and 170, at which the right-hand side data is loaded between rows 0 and 2M−1 of the systolic array, with each first element half going between rows 0 and M−1 and each second element half going to a corresponding row between rows M and 2M−1, and the left-hand side data is passed through rows 0 to 2M−1 of the systolic array, with each first element half being passed between rows 0 and M−1 and each second element half being passed to a corresponding row between rows M and 2M−1.

In further examples, the systolic processors may further differentiate between additional data types and further control different data flows for the different data types. For instance, the data type indicator may differentiate between 16-bit floating point and 8-bit floating point values, whereby an 8-bit floating point indicator may signal the systolic processors to convert the incoming left-hand side and right-hand side operands from 8-bit to 16-bit floating point format. One example arrangement for a systolic processor to convert 8-bit floating point values into 16-bit floating point values is shown in FIG. 11. The arrangement 1100 of FIG. 11 shows four registers 1110, 1120, 1130, 1140 being used to prepare right-hand side and left-hand side operands for being loaded into and passed through the systolic array 1150, respectively. The left-hand side data is first stored in a first matrix staging register (MSR_A) 1110 that is capable of supporting operands in the 8-bit floating point format. Next, the left-hand side data is moved from the first matrix staging register 1110 to a left-hand matrix register 1120 for loading into the systolic array. Since the systolic array does not support matrix multiplication operations for 8-bit floating point data, the 8-bit floating point operands may be converted from 8-bit floating point format to 16-bit floating point format during the transfer from the first matrix staging register 1110 to a left-hand matrix register 1120. Similar operations may be carried out for the right-hand side data using a second matrix staging register 1130 and a right-hand matrix register 1140, respectively. Additionally, while FIG. 11 shows the first matrix staging register 1110 being connected to the left-hand matrix register 1120 and the second matrix staging register 1130 being connected to the right-hand matrix register 1140, it should be understood that each of the matrix staging registers 1110, 1130 may be interchangeably connected to either one of the left-hand matrix register 1120 or the right-hand matrix register 1140, such that each matrix staging register 1110, 1130 may be used to store either one of the left-hand side data or the right-hand side data. In addition to the data format conversion benefits provided by the four registers, it should be noted that the four registers can provide additional functionality to the systolic processor. For example, data transferred to the matrix staging registers can be transposed at the time of the transfer, meaning that both left-hand side data and right-hand side data can be set up for matrix multiplication operations in transposed form within the systolic processor, and without having to rely on a separate transpose unit remote from the systolic processor.

Additionally or alternatively, the data type indicator may differentiate between floating point values and integer values, whereby the incoming floating point values and integer may be directed to separate DPAs for processing within the cells of the systolic array. In some examples, moving integer values to DPAs may involve each cell receiving data from two vectors from the left-hand side data during each cycle of the matrix multiplication operation, and moving the received data to different integer DPAs within the cell for initial parallel processing and subsequent combined processing.

In one example embodiment of the present disclosure, the systolic array may be used as a matrix multiplication unit (MXU) within a tensor processing unit (TPU). For instance, the TPU may include one or more core processors, and each core processor may be connected to one or more MXUs. The MXU may be an inner product step systolic array processor. The MXU may further be configurable between a shape of 128×128 and 256×128 depending on the data type being received. The MXU may support producing 2×128 24-bit results per cycle for both 8-bit and 4-bit integer operands, and providing 1×128 32-bit floating point results per cycle for both 16-bit and 8-bit floating point operands.

The example MXUs, and more generally systolic arrays, of the present disclosure, provide increased versatility and efficiency for matrix multiplication operations by supporting several types of input data using common input lines and common output lines. This helps to reduce an overall footprint of TPUs and other chips incorporating MXUs and systolic arrays therein, without sacrificing processing efficiency.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for performing matrix multiplication of input data including left-hand side data and right-hand side data, comprising:
a right-hand matrix register having size M×N;
a systolic array of data processing cells configurable between a first size M×N and a second size 2M×N; and
a systolic processor configured to:
receive a data type indicator indicating a data type of the input data;
(i) in response to the data type indicator indicating a first data type:
load the right-hand side data from the right-hand matrix register into the data processing cells between rows 0 and M−1; and
pass each respective row of the left-hand side data through a corresponding row of the systolic array between rows 0 and M−1;
(ii) in response to the data type indicator indicating a second data type:
split each element of the left-hand side data and the right-hand side data into respective first and second element halves;
load each first element half from the right-hand matrix register into the data processing cells between rows 0 and M−1; and
load each second element half from the right-hand matrix register into the data processing cells between rows M and 2M−1; and
for each respective row of the left-hand side data:
pass the first element half of the respective row of the left-hand side data through a corresponding row of the data processing cells between rows 0 and M−1; and
pass the second element half of the respective row of the left-hand side data through a corresponding row of the data processing cells between rows M and 2M−1.

2. The system of claim 1, wherein the first data type includes at least one of 8-bit integer, 8-bit floating point, or 16-bit floating point, and wherein the second data type includes 4-bit integer.

3. The system of claim 2, wherein the systolic processor is configured to:
in response to the data type indicator indicating 16-bit floating point or 8-bit floating point, pass a vector of elements of the left-hand side data having shape 1*M at each matrix multiplication cycle; and
in response to the data type indicator indicating 8-bit integer, pass a vector of elements of the left-hand side data having shape 2*M per matrix multiplication cycle; and
in response to the data type indicator indicating 4-bit integer, pass a vector of elements of the left-hand side data having shape 2*2M per matrix multiplication cycle.

4. The system of claim 2, further comprising:
one or more 16-bit floating point multiply-add chains;
two additional 8-bit integer multiply-add chains for every 16-bit floating point multiply-add chain; and
two additional 4-bit multiply-add chains for every 16-bit floating point multiply-add chain,
wherein the systolic processor is configured to:
process 8-bit floating point and 16-bit floating point data using the 16-bit floating point multiply-add chain;
process 8-bit integer data using the two 8-bit integer multiply-add chains; and
process 4-bit integer data using the two 8-bit integer multiply-add chains and the two 4-bit integer multiply-add chains.

5. The system of claim 4, wherein the systolic processor is configured to produce 2×M 24-bit results per cycle for 8-bit and 4-bit integer inputs, and 1×M 32-bit results per cycle for 8-bit and 16-bit floating point inputs

6. The system of claim 1, further comprising a holding register having size M×N and configured to provide the right-hand side data to the right-hand matrix register, wherein the holding register is configured to contain at least one data type that is not supported by the systolic array, and wherein the systolic processor is configured to convert right-hand side data of an unsupported data type to right-hand side data of a supported data type as the right-hand side data is provided from the holding register to the right-hand matrix register.

7. The system of claim 6, wherein the unsupported data type is an 8-bit floating point data type, and wherein the systolic processor is configured to convert right-hand side data of the unsupported data type contained in the holding register to the 16-bit floating point data type as the right-hand side data is provided from the holding register to the right-hand matrix register.

8. The system of claim 1, wherein data processing cell of the systolic array includes:
a floating point dot product accumulator configured to process the left-hand side and right-hand side data having a floating point data type; and
a plurality of integer dot product accumulators configured to process the left-hand side and right-hand side data having an integer data type.

9. The system of claim 8, wherein the systolic processor is configured to:
in response to the data type indicator indicating the floating point data type, pass data from one vector from the left-hand side data to the floating point dot product accumulator per matrix multiplication cycle; and
in response to the data type indicator indicating the integer data type, pass data from two vectors from the left-hand side data to the plurality of integer dot product accumulators per matrix multiplication cycle, wherein each integer dot product accumulator receives data from a respective vector of the left-hand side data.

10. The system of claim 8, wherein each integer dot product accumulator further includes separate first and second datapaths, each datapath including a respective partial product generation layer, a respective carry-save adder tree layer, and a respective reduction tree layer.

11. The system of claim 10, wherein the systolic processor is configured to:
in response to the data type indicator indicating an 8-bit integer data type, pass data from the left-hand side data to only the first datapath of each integer dot product accumulator at each matrix multiplication cycle; and
in response to the data type indicator indicating a 4-bit integer data type, pass data from the left-hand side data to both the first datapath and the second datapath of each integer dot product accumulator at each matrix multiplication cycle.

12. The system of claim 11, wherein, for each element of the left-hand data, the systolic processor is configured to:
pass the first element half to the first datapath of a corresponding one of the integer dot product accumulators; and
pass the second element to the second datapath of the second corresponding one of the integer dot product accumulators.

13. An accelerator hardware unit comprising the system of claim 1, wherein the accelerator hardware unit is one of a graphics processing unit or a tensor processing unit.

14. The accelerator hardware unit, comprising a plurality of matrix multiplication units, wherein at least one of the matrix multiplication units includes the system of claim 1.

15. A method for performing matrix multiplication in a systolic array of data processing cells configurable between a first size of M×N and a second size of 2M×N, the method comprising:
receiving, by one or more processors, a data type indicator indicating a data type of input data for the matrix multiplication, wherein the input data include left-hand side data and right-hand side data;
(i) in response to the data type of the data type indicator indicating the first data type:
loading, by the one or more processors, the right-hand side data from a right-hand matrix register having size M×N into the data processing cells of the systolic array between row 0 and row M−1; and
for each respective row of the left-hand side data, passing, by the one or more processors, the respective row of the left-hand side data through a corresponding row of the data processing cells of the systolic array between row 0 and row M−1 to derive a matrix multiplication result of the left-hand side data with the right-hand side data;
(ii) in response to the data type of the data type indicator indicating the second data type:
splitting, by the one or more processors, each element of the left-hand side data and the right-hand side data into respective first and second element halves;
loading, by the one or more processors, each first element half from the right-hand matrix register into the data processing cells of the systolic array between row 0 and row M−1; and
loading, by the one or more processors, each second element half from the right-hand matrix register into the data processing cells of the systolic array between row M and row 2M−1;
for each respective row of the left-hand side data:
passing, by the one or more processors, the first element half of the respective row of the left-hand side data through a corresponding row of the data processing cells of the systolic array between row 0 and row M−1; and
passing, by the one or more processors, the second element half of the respective row of the left-hand side data through a corresponding row of the data processing cells of the systolic array between row M and row 2M−1,
to derive the matrix multiplication result of the left-hand side data with the right-hand side data.

16. The method of claim 15, wherein the first data type includes at least one of 16-bit floating point, 8-bit floating point or 8-bit integer, and wherein the second data type includes 4-bit integer, and wherein:
in response to the data type indicator indicating the first data type, passing the left-hand side data comprises passing one or more vectors of elements of the left-hand side data to only rows 0 through M−1 of the systolic array at each matrix multiplication cycle; and
in response to the data type indicator indicating the second data type, passing the left-hand side data comprises passing one or more vectors of elements of the left-hand side data to all rows between 0 through 2M−1 of the systolic array at each matrix multiplication cycle.

17. The method of claim 16, wherein, in response to the data type indicator indicating the second data type, passing the left-hand side data comprises passing two vectors of elements of the left-hand side data to a plurality of integer dot product accumulators included in each cell of the systolic array per matrix multiplication cycle, wherein each cell includes two integer dot product accumulators, and wherein each pair of corresponding rows corresponds to a pair of separate datapaths within a corresponding one of the plurality of integer dot product accumulators.

18. The method of claim 15, wherein the data type indicator further differentiates between integer and floating point data types, and wherein:
in response to the data type indicator indicating the floating point data type, passing the left-hand side data comprises passing one vector of elements of the left-hand side data to the systolic array at each matrix multiplication cycle; and
in response to the data type indicator indicating the integer data type, passing the left-hand side data comprises passing two vectors of elements of the left-hand side data to the systolic array at each matrix multiplication cycle.

19. The method of claim 15, further comprising:
storing the right-hand side data in a holding register having size M×N, the right-hand side data being a data type that is not supported by the systolic array;
loading the right-hand side data from the holding register into the right-hand matrix register, wherein said loading comprises converting, by the one or more processors, the right-hand side data into a data type that is supported by the systolic array, wherein the data type that is not supported by the systolic array is 8-bit floating point and wherein the data type that is supported by the systolic array is 16-bit floating point.

20. The method of claim 15, wherein the left-hand side and right-hand side data are received as 128×128 matrices, wherein M=128 and N=128, and wherein the method further comprises:
for data inputs including 8-bit or 16-bit floating point operands, producing 1×128 32-bit floating point results for each cycle of the systolic array; and
for data inputs including 4-bit or 8-bit integer operands, producing 2×128 24-bit results for each cycle of the systolic array.
